(19) United States
(12) Patent Application Publication
(10) Pub. No.: US 2012/0164267 A1
(43) Pub. Date: Jun. 28, 2012

(54) METHOD FOR OBTAINING CHEWING GUM, IN WHICH TALC IS REPLACED WITH AGGLOMERATES OF CRYSTALS

(75) Inventors: Baptiste Boit, Bethune (FR); Philippe Lefevre, Haverskerque (FR); Jose Lis, La Gorgue (FR); Dominique Ortiz De Zarate, Merville (FR)

(73) Assignee: ROQUETTE FRERES, Lestrem (FR)

(21) Appl. No.: 13/393,619

(22) PCT Filed: Aug. 6, 2010
(86) PCT No.: PCT/FR10/51677

§ 371 Date: Mar. 1, 2012

(30) Foreign Application Priority Data
Sep. 1, 2009 (FR) 09 55960

(51) Int. Cl. A23G 4/06

(52) U.S. Cl. 426/5

(57) ABSTRACT

A chewing gum production method includes a step in which the ingredients are mixed together, a mixture-extrusion step, a dusting step using a dusting powder, a sheeting step and a shaping/cutting step. The dusting powder includes a powder composition of agglomerates of crystals, the powder composition including at least one polyol. The resulting chewing gum is also described.

The present invention relates to a method for producing a chewing gum and more particularly to the partial or complete replacement of talc in said method.

Processes for producing chewing gums generally comprise five steps (Formulation and production of chewing and bubble gum, edited by Douglas Fritz, Kennedy's Publications Ltd, London, UK). During the first step, the various compounds are mixed using a kneading machine comprising 2 Z-shaped blades. The complete cycle of the operation lasts from 15 to 20 minutes and the ingredients are added as the kneading proceeds in the kneading machine. In order to render the gum base malleable, the latter is heated beforehand and during mixing. At the end of kneading, the temperature of the paste is approximately 50° C. Two main groups are distinguished among the constituent ingredients of chewing gums, which groups are the elements which are insoluble in water and thus in the saliva, such as mainly the base gum, and the components which are soluble in water, conferring on the chewing gum its flavor, such as sweeteners in particular. The mixing step is followed by a second step of extrusion under hot conditions in order to obtain a strip of chewing gum which is narrower or wider according to the device used. In order to reduce the thickness of the strip obtained, a rolling step is provided. During this step, the strip passes successively between several pairs of rollers of decreasing separation. The rolling step is followed by a final step of forming/cutting, which can be a single step of forming combined with a cutting or preliminary cutting of the strip obtained before packaging. In point of fact, after the step of extrusion under hot conditions, the strip of gum is extremely sticky. In fact, in order to prevent it from being destroyed or losing its integrity during rolling, a step of dusting on both faces of the strip is conventionally carried out between the steps of extrusion and of rolling. Numerous agents are used in the dusting powders. Thus, plasticizing agents or anticaking agents, such as talc, calcium carbonate, tricalcium phosphate, silica or silicates, are encountered. All these inorganic agents are capable of damaging the organoleptic properties of the chewing gums obtained. This is because these agents are insoluble and are without flavor, indeed even unpleasant, in the mouth.

Furthermore, the most widely used powder for dusting is talc. In point of fact, talc may be contaminated by a product having a very similar yet nevertheless very toxic chemical nature: asbestos. Thus, contaminated talc might be involved in processes of cancerization, whether of the digestive tract, following absorption by the oral route, or of pulmonary tissue, during absorption by the respiratory route, in particular during the handling thereof. The handling of talc is thus regulated and respiratory protective equipment is obligatory for production personnel.

In order to reduce the amounts of talc incorporated during the preparation of chewing gums and while preventing the dusting powder from being felt on the tongue during the tasting of the chewing gum, use has been made for a long time of icing sugar with a particle size close to that of talc (powder with a particle size of less than 40 μm and with a mean diameter of less than 10 μm). This use was always carried out as a mixture as icing sugar has very poor flow. Icing sugar was then replaced with powders formed of non-hygroscopic polyols, such as in particular mannitol. In the same way as for icing sugar, the powders formed of polyols used have very fine particle sizes. The most widely used powders have an amount of particles of less than 75 μm of the order of 95 to 75% for a mean particle size of 65 to 20 μm. Thus, the richness in particles having fine particle sizes was for a long time regarded as very favorable in this application, whether with regard to the gritty nature or the replacement of the talc.

However, complete replacement of the talc by these powders is not recommended since they have very poor flow, rendering them unsuitable for dusting. In the case of partial replacement, the talc, which has good flow, confers a flow on the mixture which is still mediocre but sufficient to allow the dusting of the strip of chewing gum. In point of fact, even in the context of partial replacement of the talc, the reduction in flow of the powder mixture is such that it constricts the deposition of a large amount of powder on the strip of chewing gum, resulting in fact in significant waste, in a deterioration in the quality of the chewing gums obtained, or in a modification to the conditions for regulating the devices.

Furthermore, the small particle size of these powders increases the generation of dust in suspension in the air, thus accentuating the risks for the handlers associated with the presence of asbestos in the talc.

In addition, the dusting powders do not always make it possible to obtain a uniform dusting layer. Thus, the creation is observed of nondusted or insufficiently dusted regions constituting regions of sticking of the strip of chewing gum to the rolling instruments, which are responsible for the deterioration in the strips and in fact the interruption of the manufacturing process.

Finally, a phenomenon of solidification, in their packaging, of the powders formed of polyols having fine particle sizes is observed. This is because these powders are unstable in that they cake on storage or during transportation. The bodies obtained can only be broken up by exerting very high forces. This phenomenon presents a problem in the context of the production of chewing gum in that it may be responsible for the formation of compact aggregates capable of blocking the equipment for dusting the chewing gums.

Although the use of anticaking agents in the food industry results in regulatory constraints since they may be regarded as toxic or dangerous, this solution has been envisaged. However, while a reduction in the caking has been demonstrated in the case of powders formed of hygroscopic polyols, no similar change in behavior was observed for powders formed of polyols having little or no hygroscopicity.

In order to have an efficient process, which is easy to implement, without danger to the handlers, which makes it possible to obtain a chewing gum comprising no or little in the way of inorganic agents, such as talc, while maintaining, indeed even improving, the organoleptic qualities of the chewing gums obtained, the invention relates to a method for producing chewing gums comprising a step of mixing the ingredients, a step of extruding the mixture, a step of dusting with a dusting powder, a step of rolling and a step of forming/cutting, in which the dusting powder comprises a pulverulent composition formed of agglomerates of crystals, said pulverulent composition comprising at least one polyol (also known as sugar alcohol).

The pulverulent composition according to the invention makes possible complete or partial replacement of inorganic agents of anticaking or plasticizing types, such as talc, during the step of dusting the strip of chewing gum, while maintaining an efficient method and while retaining the organoleptic qualities of the chewing gum obtained.

Within the meaning of the invention, the step of mixing the ingredients relates to the step of mixing the base gum with the flavorings and any other ingredient in order to obtain the paste to be chewed, which will be extruded and then dusted before being rolled and then cut up or formed.

Within the meaning of the invention, “crystals” is understood to mean a crystalline composition produced from the crystallization of a polyol solution (a polyol in a solvent) or of a polyol melt (solid melted in the absence of solvent).

The expression crystalline composition also covers the compositions obtained by a grinding subsequent to the crystallization step. The crystalline composition can be a mixture of crystals of several polyols.

According to the invention, the expression “composition formed of agglomerates of crystals” is understood to mean a composition obtained by agglomeration of crystals. A composition suitable for the implementation of the method according to the invention can be obtained by the wet granulation technique or by the dry granulation technique. Such technologies are described in the literature (Agglomeration Processes, Phenomena, Technologies, Equipment by Wolfgang Pietsch, Chapter 6, “Agglomeration Technologies”, Wiley-VCH, 2002).

In the case of the wet granulation technique, three technologies are conventionally employed: the mixer technology, the fluidization technology and the compression technology. The mixer technology can be carried out with low or high shear. The fluidization technology can be carried out on fluidized air bed granulators or in spray-drying towers. The compression technology is carried out on extruders, graters, screens or perforated plates.

These technologies can be operated batchwise or continuously. They are combined with a step of drying, simultaneously or subsequently, a step of cooling and an optional step of classification with recycling of the undesired fractions of products.

In a first preferred embodiment of the method, use may be made, for example, of a vertical continuous mixer-agglomerator of Schugi Flexomix type sold by Hosakawa, in which the starting crystals to be agglomerated are introduced continuously via a weight metering device and the binder is introduced continuously via a volumetric metering device, the binder being in the form of a liquid, a powder or a suspension. In this method, the starting crystals and the binder are intimately mixed in the mixer-agglomerator equipped with a shaft with knives positioned as blades and with a system for spraying liquids via injection nozzles. It will be possible to preferably choose a twin-fluid nozzle in which the binder is converted into the form of fine droplets by a fluid under pressure. The choice will advantageously be made of compressed air or pressurized water steam.

In a preferred form of the method, the satisfactory dispersion of the constituents and the agglomeration of the starting crystals are produced by stirring at high speed, that is to say with a value at least equal to 2000 rpm, preferably at least equal to 3000 rpm. At the outlet of the mixer-agglomerator, the agglomerates formed are continuously discharged by gravity into a dryer.

This second step of drying at the outlet of the mixer-agglomerator makes it possible to remove the solvent originating from the binder and to give solidity to the agglomerates. The dryer can be, for example, a fluidized bed dryer or a rotary drum dryer.

The composition formed of agglomerates of crystals in accordance with the invention is obtained after cooling and optionally sieving. In this case, the fine particles can be directly recycled at the start of granulation and the coarse particles can be ground and recycled at the start of sieving or at the start of granulation.

In a second preferred embodiment of the method, the choice is made to carry out the wet granulation of the crystals in a spray-drying tower. The crystals and the binder are then introduced continuously into said spray-drying tower in the form of fine droplets via a spray nozzle. In this method, it is ensured that the starting crystals and the binder are brought intimately into contact. For this, the crystals are injected into the atomization spray of the binder.

In a preferred form of the method, the choice is made to use an MSD (Multi-Stage Dryer) spray-drying tower sold by Niro having a water evaporation capacity of the order of 350 kg/h. The starting crystals are then fed continuously at a flow rate of between 400 and 600 kg/h approximately, the wet granulation being carried out with a solvent, such as water, as binding agent, as will be exemplified below. Satisfactory spraying of the binder is provided by a high-pressure spray nozzle. The agglomerates of crystals obtained are subsequently cooled on a vibrated fluidized bed. In view of the melting points of the crystals, the Applicant Company found that it was necessary to very closely monitor the operating temperatures of the spray-drying tower.

According to a preferred form, the composition formed of agglomerates of crystals comprises a flow grade of between 55 and 90, preferably between 60 and 85 and more preferably between 65 and 80.

The ability to flow is evaluated using the Powder Tester device of PTE type sold by Hosokawa. This device makes it possible to measure, under standardized and reproducible conditions, the ability to flow of a powder and to calculate a flow grade, also known as flowability index, on the basis of the studies of Mr. Ralph Carr (1965). The flow grade is calculated from the values obtained by carrying out the four following tests: compressibility, angle of repose, angle of spatula and uniformity (see technical manual of the Powder Tester device of PTE type). For this last test, the particle size used is that obtained by laser particle size analysis described below.

The good flow of the pulverulent composition makes possible easy implementation of the method without major modification to the processing conditions in comparison with the use of talc.

According to an alternative form of the invention, the pulverulent composition comprises at least one polyol having a hygroscopicity of between 0.01 and 5%, preferably between 0.05 and 3% and more preferably between 0.08 and 1%.

Preferably, said at least one polyol is a predominant polyol (more than 50% of the polyols of the pulverulent composition), so that the composition comprises a hygroscopicity of between 0.01 and 5%, preferably between 0.05 and 3% and more preferably between 0.08 and 1%.

Advantageously, the pulverulent composition according to the invention comprises less than 60%, preferably from 50% to 0.1%, preferably from 40% to 1%, more preferably from 35 to 2% and more preferably still from 25% to 5% of particles with a diameter of less than 75 μm.

“Particles of less than 75 μm” is understood to mean any particle, capable of being detected using a laser diffraction particle size analyzer of LS 230 type from Beckman-Coulter, with a particle size from 75 μm to 0.4 μm.

Thus, the particle size distribution values are determined on a laser diffraction particle size analyzer of LS 230 type from Beckman-Coulter, equipped with its module for powder dispersion by aspiration (1400 watts aspirator) of the sample (dry route), by following the technical manual and the manufacturer's specifications.

The operating conditions for subhopper screw speed and intensity of vibration of the dispersion chute are determined so that the optical concentration is between 4% and 12%, ideally 8%.

The measurement range for the laser diffraction particle size analyzer of LS 230 type is from 0.4 μm to 2.000 μm. The results are calculated as % by volume and are expressed in μm. The calculation method used is that according to the Fraunhofer theory.

The measurements give us the content of fines of less in particular than 75 μm. The particle size distribution curve also makes it possible to determine the value of the volume mean diameter (arithmetic mean) D4,3.

The test for measuring the hygroscopicity consists here in evaluating the variation in weight of the sample measured when it is subjected to different relative humidities (R.H.) at 20° C. in an apparatus manufactured by Surface Measurements Systems (London, UK) and referred to as Dynamic Vapor Sorption Series 1.

This apparatus consists of a microbalance which makes it possible to quantify the change in weight of a sample with respect to a reference (in this instance, the reference boat of the differential balance is empty) when the sample is subjected to different climatic conditions.

The carrier gas is nitrogen and the weight of the sample is between 10 and 11 mg. The programmed R.H. values are 20, 40, 60 and 80%. The stability factor which makes possible the automatic change from one R.H. to the following one is the dw/dt ratio, which is set at 0.002% for 20 minutes.

In the end, the hygroscopicity expressed is the result of the following calculation: [(w80-w20)/w20]×100, where w20 is the weight of the sample at the end of the time for maintaining at 20% R.H. and w80 is the weight of the sample at the end of the time for maintaining 80% R.H.

In order for the dusting to be able to be carried out under relative temperature and humidity conditions which are standard in production plants, it is preferable to use a weakly hygroscopic powder.

Typically, the pulverulent composition is an agglomerate of crystals comprising from 50 to 100% of a polyol, preferably from 75 to 99%, more preferably from 85 to 98.5%, more preferably still from 90 to 98% and very preferably from 92 to 97% of a polyol.

According to an alternative form of the invention, the polyol is a hydrogenated monosaccharide or a hydrogenated disaccharide or their mixture, preferably chosen from mannitol, isomalt, xylitol, maltitol, erythritol, lactitol, sorbitol or their mixtures. Preferably, the polyol is chosen from erythritol, mannitol, isomalt and their mixtures.

Preferably, the pulverulent composition exhibits a mean diameter (arithmetic mean) D4,3 of between 75 μm and 400 μm, preferably between 100 μm and 350 μm and more preferably between 110 μm and 250 μm, more preferably still between 125 and 240 μm, typically between 150 and 225 μm.

According to the invention, the agglomerates of crystals are obtained by granulation of crystals, said crystals being obtained by single or fractional crystallization.

Typically, the agglomerates of crystals are obtained by granulation of crystals, said crystals being obtained by crystallization by cooling a melt, by evaporation or evaporative crystallization of a polyol solution or by addition of a diluent.

According to a first alternative form, the crystallization is single and is carried out by thermal processes, such as by cooling a polyol melt, by evaporation. The evaporation can be partial and can make possible, by the concentration of the polyol solution, crystallization in the form of predominantly individual crystals. It can be total and can make possible crystallization in the form of granules formed of crystals, for example by spraying the polyol solution. “Granules” is understood to mean a structure exhibiting a spherical shape in scanning microscopy.

Preferably, the crystals obtained are in the form of predominantly individual crystals.

Evaporation is described as adiabatic when the vaporization of the solvent brings about a reduction in temperature; the term used is evaporative crystallization.

According to a second alternative form, crystallization is single and is carried out by physicochemical processes. Typically, crystallization is carried out by addition of a diluent, more particularly of an organic solvent, such as an alcohol.

According to a third alternative form, crystallization is carried out fractionally, that is to say by successive crystallizations; the crystals obtained at each step are solubilized or dissolved in a solvent or melted and then crystallized again.

Typically, the crystallization step is followed by a step of selecting the particles, optionally preceded by a grinding of the crystals obtained.

Preferably, the selection of particles is carried out by sieving or on an air separator.

According to an alternative form of the invention, the pulverulent composition comprises a protein or a polysaccharide chosen from starches, maltodextrins, dextrins, gums, pectin and cellulose derivatives or their mixture.

Typically, the proteins are chosen from fibrous proteins, such as collagen or the product of its partial hydrolysis. The example of a product from the hydrolysis of collagen is gelatin.

“Polysaccharides” is understood to mean polymers formed from a certain number of monosaccharides. Among these polysaccharides, a distinction is made between homopolysaccharides, composed of the same monosaccharide, and heteropolysaccharides, formed of different monosaccharides.

Advantageously, said polysaccharide exhibits:
between 15 and 50% of 1-6 glucoside bonds, preferably between 22 and 45% and more preferably between 27 and 34%,
a content of reducing sugars of less than 20%, preferably of between 2 and 20%, more preferably between 3 and 16% and more preferably still between 3 and 12%,
a polymolecularity index of less than 5, preferably of between 0.5 and 4 and more preferably between 1 and 3.5, and
a number-average molecular weight Mn of less than 4500 g/mol, preferably of between 500 and 4500 g/mol, more preferably of between 600 and 4000 g/mol and more preferably still of between 1000 and 2700 g/mol.

A pulverulent composition according to the invention comprises polysaccharides or proteins incorporated in the liquid or powder form as granulation binder during the granulation of polyol crystals.

Preferably, the polysaccharide is chosen from starches, maltodextrins or dextrins or their mixtures.

Maltodextrins are conventionally obtained by acid and/or enzymatic hydrolysis of starch. They include a complex mixture of linear or branched saccharides. From the regulatory viewpoint, maltodextrins have a dextrose equivalent (DE) of from 1 to 20.

Mention may be made, among the preferred starches and maltodextrins, of starches or maltodextrins of cereals, such as rice, corn, wheat or sorghum, of tuberous plants, such as potato, cassava or sweet potato, or of leguminous plants. The term leguminous plants is understood to mean any plant belonging to the families of the Caesalpiniaceae, Mimosaceae or Papilionaceae and in particular any plant belonging to the family of Papilionaceae, such as, for example, pea, bean, broad bean, horse bean, lentil, alfalfa, clover or lupin.

Advantageously, the dusting powder comprises less than 50%, preferably less than 45%, indeed even less than 35%, typically from 10 to 0.1%, of a silicate or carbonate. According to a preferred alternative form, the dusting powder is devoid of talc.

Within the meaning of the present invention, the silicate is chosen from natural hydrated magnesium silicate or its equivalent synthetic versions, such as magnesium silicate, magnesium trisilicate, indeed even calcium silicate. Among the known carbonates, calcium carbonate is preferred.

The invention also relates to the chewing gum obtained by the implementation of the method according to the invention characterized in that it comprises, at the surface of the chewing gum, a dusting powder comprising a pulverulent composition formed of agglomerates of crystals, said pulverulent composition comprising at least one polyol.

The chewing gum according to the invention is paste to be chewed (base gum, flavorings, and the like). When the chewing gum is in the stick or lozenge form, this surface powder is necessary in order to prevent the sticks from adhering to one another or to prevent the sticks from adhering to the paper. Likewise, when the chewing gum is coated with sugar, a fine layer remains present at the surface of the base gum (or paste to be chewed), despite the removal of dust prior to the coating with sugar. This layer is visible in scanning optical microscopy.

Other characteristics and advantages of the present invention will become clearly apparent on reading the examples given below which will illustrate the invention.

### EXAMPLE 1

Samples A to Z obtained according to the processes described below are defined and identified in table 1.

A mannitol syrup comprising 96% of mannitol was crystallized according to European patent EP 0 202 168.

The first crystallization was carried out in order to obtain a product with a particle size of 135 μm (sample B); the crystals obtained are subsequently ground in order to obtain a product with a particle size of 67 μm (sample A).

Sample C is obtained by granulation on a vertical Schugi Flexomix mixer/agglomerator fed continuously, via a powder weight metering device, at a flow rate of 900 kg/h, with a crystalline mannitol B (sample B). The mixer/agglomerator is also fed continuously with water at 80° C. and at a flow rate of 115/h, via a twin-fluid spray nozzle. Good spraying is provided by air at a pressure of 2 bar. The knife-comprising rotating shaft is adjusted beforehand to the speed of 3000 rpm. The wet granulated powder at the outlet of the mixer/agglomerator falls continuously, by gravity, into a 2-compartment fluidized air bed dryer. In the first compartment, the granulated product is dried by air at 120° C. and then it is cooled to 20° C. in the second compartment.

TABLE 1

| | |
|---|---|
| Mannitol, crystals, D4, 3 = 67 μm | A |
| Mannitol, crystals, D4, 3 = 135 μm | B |
| Mannitol, agglomerated on a Schugi, D4, 3 = 198 μm | C |
| Mannitol, agglomerated on a Schugi, D4, 3 = 150 μm | D |
| Mannitol, agglomerated on a Schugi, D4, 3 = 205 μm | E |
| Mannitol, agglomerated on a Schugi, D4, 3 = 113 μm | F |
| Mannitol, agglomerated on a Schugi, D4, 3 = 168 μm | G |
| Mannitol, agglomerated on a Schugi, D4, 3 = 173 μm | H |
| Mannitol, agglomerated on a Schugi, D4, 3 = 343 μm | I |
| Maltitol, crystals, D4, 3 = 43 μm | J |
| Maltitol, agglomerated on a Schugi, D4, 3 = 89 μm | K |
| Maltitol, agglomerated on a Schugi, D4, 3 = 161 μm | L |
| Xylitol, crystals, D4, 3 = 129 μm | M |
| Xylitol, agglomerated on a Schugi, D4, 3 = 343 μm | N |
| Isomalt, crystals, D4, 3 = 51 μm | O |
| Isomalt, agglomerated on a Schugi, D4, 3 = 153 μm | P |
| Maltitol, crystals, D4, 3 = 61 μm | Q |
| Maltitol, agglomerated in an MSD tower, D4, 3 = 230 μm | R |
| Xylitol, crystals, D4, 3 = 72 μm | S |
| Xylitol, agglomerated in an MSD tower, D4, 3 = 178 μm | T |
| Xylitol/BMD, D4, 3 = 290 μm | U |
| Mannitol/starch, coatomized, granulated, D4, 3 = | V |
| 108 μm | |
| Maltitol, agglomerated, D4, 3 = 265 μm | W |
| Mannitol, compacted, D4, 3 = 223 μm | X |
| Mannitol, agglomerated (F) + 10% talc | Y |
| Mixture of 50% mannitol, crystals (A), and 50% | Z |
| maltitol, crystals (Q) | |

The granulated, dried and cold product is subsequently continuously sieved on a rotary sieve equipped with an 800 μm wire mesh. The fraction of the particles of greater than 800 μm is ground and recycled at the top of the mixer/agglomerator. The product obtained corresponds to sample C.

Samples D, E, F, G and I are obtained by the use of the same process in which spraying is carried out with pressurized steam (see table 2). In the case of sample I, the fraction of the particles of less than 100 μm is recycled at the top of the mixer/agglomerator.

TABLE 2

| | C | D | E | F | G | H | I |
|---|---|---|---|---|---|---|---|
| Starting | B | B | B | A | A | A | B |
| crystals | | | | | | | |
| Powder flow | 900 | 900 | 900 | 900 | 900 | 900 | 550 |
| rate (kg/h) | | | | | | | |
| Binder flow | 115 | 50 | 80 | 50 | 80 | 115 | 65 |
| rate (l/h) | | | | | | | |
| Binder | Water | Water | Water | Water | Water | Water | Water |
| | 80° C. | 80° C. | 80° C. | 80° C. | 80° C. | 80° C. | 80° C. |
| Twin-fluid | Air | Steam | Steam | Steam | Steam | Air | Steam |
| nozzle | | | | | | | |
| Pressure | 2 | 2.5 | 2.5 | 4 | 4 | 2 | 3.5 |
| (bar) | | | | | | | |
| Drying air | 120 | 60 | 85 | 75 | 95 | 95 | 85 |
| temperature | | | | | | | |
| (° C.) | | | | | | | |
| Sieve | <800 μm | <800 μm | <800 μm | <800 μm | <800 μm | <800 μm | 100 μm < |
| | | | | | | | <800 μm |

Samples J and Q are crystalline maltitol obtained by the use of a crystallization process as described in European patent EP 0 905 138. The powder obtained is subsequently ground in order to obtain a product with a particle size of approximately 40 μm (sample J) and 60 μm (sample Q).

Samples K and L are obtained by the use of the granulation process from sample J with the Schugi agglomerator according to the steps described above and under the flow rate, pressure and temperature conditions defined in table 3. Sample K is granulated with water and sample L is granulated with a maltitol syrup having a solids content of 50% with the Schugi agglomerator according to the steps described above and under the conditions defined in table 3.

Samples M and S are obtained by crystallization from water of a xylitol syrup. Cristallization was carried out in order to obtain a product with a particle size of approximately 130 μm (sample M). Sample M is subsequently ground in order to obtain a powder with a particle size of 72 μm (sample S).

Sample N is obtained by granulation of sample M by the use of a vertical continuous mixer/agglomerator of Flexomix type from Hosokawa Schugi according to the steps described above and under the flow rate, pressure and temperature conditions defined in table 3.

Sample O is obtained by crystallization according to the conditions described in patent EP 1 674 475; the crystalline powder obtained is subsequently ground so as to obtain a powder having a mean particle size of 51 μm.

Sample P is obtained by the use of the granulation process with the Schugi agglomerator from sample O according to the conditions described in table 3.

Sample Z is obtained by the use of the granulation process with the Schugi agglomerator from samples A and Q in a 1/1 ratio according to the conditions described in table 3.

TABLE 3

| | K | L | N | P | Z |
|---|---|---|---|---|---|
| Starting | J | J | M | O | 50% A |
| crystals | | | | | 50% Q |
| Powder flow | 500 | 500 | 500 | 500 | 500 |
| rate (kg/h) | | | | | |
| Binder flow | 25 | 25 | 40 | 65 | 80 |
| rate (l/h) | | | | | |
| Binder | Water | Maltitol | Water | Water | Water |
| | 80° C. | 50% DM | 80° C. | 80° C. | 80° C. |
| | | 80° C. | | | |
| Twin-fluid | Air | Air | Air | Air | Air |
| nozzle | | | | | |
| Pressure | 2 | 2 | 2 | 2 | 2 |
| (bar) | | | | | |
| Drying air | 70 | 100 | 80 | 90 | 120 |
| temperature | | | | | |
| (° C.) | | | | | |
| Sieve | <800 μm | <800 μm | <800 μm | <800 μm | <800 μm |

Sample R was obtained by granulating sample Q in an MSD spray-drying tower.

The MSD spray-drying tower used comprises an evaporation capacity of 350 kg/h and is fed via a powder weight metering device with crystalline maltitol Q (sample Q) at a flow rate of 500 kg/h. Granulation is carried out by spraying water at a flow rate of 110 1/h via a nozzle at a pressure of 50 bar. The main drying air enters the tower at 180° C. and the drying air of the static bed enters the tower at 70° C. The temperature of the outlet vapors is then 90° C. (table 4). On leaving from the spray-drying tower, the product passes over a vibrated fluid bed, where it is cooled by air in 3 temperature regions respectively set at 35° C., 20° C. and 20° C.

Sample T was obtained by granulating sample S in an MSD spray-drying tower according to the steps described above and the conditions described in table 4.

TABLE 4

| | R | T |
|---|---|---|
| Starting crystals | Q | S |
| Powder flow rate | 500 | 500 |
| (kg/h) | | |
| Binder flow rate | 110 | 70 |
| (l/h) | | |
| Binder | Water 80° C. | Water 80° C. |
| Nozzle pressure | 50 | 40 |
| (bar) | | |
| Drying air Tp (° C.) | 180 | 135 |
| Static bed air Tp | 70 | 75 |
| (° C.) | | |
| Outlet vapors Tp | 90 | 75 |
| (° C.) | | |

Sample U is obtained by granulation with an aqueous solution comprising 30% as dry matter (DM) of branched maltodextrins (BMD) (sold by the Applicant Company under the name Nutriose® FM06). 500 g of a 77 μm xylitol powder are deposited in the container of the dryer/agglomerator having a fluidized air bed of Strea-1 type from Aeromatic equipped with an injection nozzle.

The xylitol powder is suspended at a temperature of 60° C. by air pulsed at the base of said container. The solution of branched maltodextrins is subsequently sprayed at a flow rate of 4 ml/min and at a pressure of 1 bar. The granules, recovered after a residence time of from 25 to 30 min, are recovered and dried in said agglomerator at 60° C. for 30 minutes. The granules are subsequently graded on a graded sieve with a mesh size of between 100-500 μm. The pulverulent composition obtained is composed of 95% xylitol and 5% branched maltodextrins.

Sample V is a granulated coatomized mixture of starch and mannitol in a starch/mannitol ratio (by weight) of 20/80. It is obtained by spraying a suspension of mannitol crystals (sample A) and starch (“extra white” corn starch) in a spray-drying tower of MSD (i.e. Multi-Stage Dryer) type equipped with a high-pressure spray nozzle with recycling of the fine particles at the top of the tower (MSD 20 tower sold by Niro). The suspension is prepared at 20° C.

The operating conditions for manufacturing these coagglomerates appear in the following table 5.

TABLE 5

| | |
|---|---|
| Dry matter (%) | 55 |
| Pressure (bar) | 30 |
| Nozzle (Spraying System type SK) | 52 * 21 |
| Upstream air temperature (° C.) | 155 |
| Temperature of the static fluidized bed | 84 |
| (° C.) | |
| Outlet air temperature (° C.) | 60 |

Sample W is a maltitol powder obtained by wet granulation of a crystalline maltitol with a maltitol syrup according to the following conditions:

25 kg of sample Q are introduced into a Glatt AGT 400 granulator operating in batch mode (the outlet of the air classifier is closed). The inlet air flow rate is regulated at 800 m³/h with a temperature of 100° C. (so as to obtain a speed of the fluidizing air at a value of between 1 and 2 m/s). A syrup with a solids content of 27% and where the maltitol richness is 75%, composed of 1.7 kg of maltitol of Maltisorb® 75/75 type (sold by the Applicant Company) diluted with 3 kg of water, is sprayed at a temperature of 40° C. using a twin-fluid nozzle (air pressure of 4 bar) in the bottom spray position over the maltitol particles moving in the air stream. The flow rate of the spraying is regulated so as to obtain a temperature in the bed of moving particles of 31° C. (air flow rate 800 m³/h, air temperature during the spraying 100° C.) At the end of the spraying, the temperature of the air is increased up to 120° C. These conditions are maintained until the temperature in the powder bed has risen to 75° C.

The powder is subsequently cooled to 20° C. and then sieved between 100 and 500 μm.

Sample X is obtained by dry granulation of sample A. Sample A was compacted on an Alexanderwerk WP120 roller compacter. The compacting pressure is regulated at 40 bar. The two successive granulators are successively equipped with screens of 1600 μm and then of 600 μm.

Sample Y is produced using a Mixomat A14 (Fuchs/Switzerland) tumbler mixer. The powders to be mixed are introduced into a can with a working volume of 5 liters (total volume of 6 liters) which is set in motion in this mixer for 15 minutes. The amounts employed are 1.500 kg of agglomerated mannitol sample F and then 150 g of talc.

TABLE 6

| Sample | A | B | C | D | E | F | G | H | I | J | K | L | M |
|---|---|---|---|---|---|---|---|---|---|---|---|---|---|
| Content of | 65.9 | 33.5 | 13.0 | 29.6 | 15.2 | 56.2 | 21.9 | 24.6 | 3.8 | 84.4 | 35.2 | 8.8 | 30.3 |
| particles of | | | | | | | | | | | | | |
| less than | | | | | | | | | | | | | |
| 75 μm (%) | | | | | | | | | | | | | |
| Mean diameter | 67 | 135 | 198 | 150 | 205 | 113 | 168 | 173 | 343 | 43 | 89 | 161 | 129 |
| (μm) | | | | | | | | | | | | | |
| Flow grade | 41.5 | 51.5 | 72 | 66 | 73 | 54 | 66 | 63 | 77 | 47 | 63 | 76 | 41 |
| (out of 100) | | | | | | | | | | | | | |
| Aerated | 0.45 | 0.53 | 0.64 | 0.57 | 0.58 | 0.52 | 0.54 | 0.56 | 0.59 | 0.38 | 0.56 | 0.51 | 0.45 |
| density (g/ml) | | | | | | | | | | | | | |
| Packed density | 0.79 | 0.82 | 0.78 | 0.76 | 0.71 | 0.77 | 0.69 | 0.73 | 0.66 | 0.83 | 0.72 | 0.59 | 0.86 |
| (g/ml) | | | | | | | | | | | | | |
| Hygroscopicity | 0.11 | 0.09 | 0.09 | 0.11 | 0.10 | 0.12 | 0.10 | 0.09 | 0.10 | 0.11 | 0.13 | 0.35 | 0.09 |

TABLE 7

| Sample | N | O | P | Q | R | S | T | U | V | W | X | Y | Z |
|---|---|---|---|---|---|---|---|---|---|---|---|---|---|
| Content of | 2.4 | 78.2 | 10.7 | 71.1 | 12.5 | 58.7 | 15.6 | 2.2 | 42 | 4.5 | 17.6 | 68.4 | 10.9 |
| particles of | | | | | | | | | | | | | |
| less than | | | | | | | | | | | | | |
| 75 μm (%) | | | | | | | | | | | | | |
| Mean diameter | 341 | 51 | 153 | 61 | 230 | 72 | 178 | 290 | 108 | 265 | 223 | 79.6 | 184 |
| (μm) | | | | | | | | | | | | | |
| Flow grade | 68 | 49 | 74 | 47 | 65 | 34 | 68 | 80 | 72 | 85.5 | 61 | 59 | 74 |
| (out of 100) | | | | | | | | | | | | | |
| Aerated | 0.57 | 0.42 | 0.54 | 0.50 | 0.56 | 0.45 | 0.54 | 0.71 | 0.52 | 0.68 | 0.62 | 0.52 | 0.55 |
| density (g/ml) | | | | | | | | | | | | | |
| Packed density | 0.66 | 0.78 | 0.66 | 0.89 | 0.69 | 0.89 | 0.63 | 0.78 | 0.63 | 0.71 | 0.77 | 0.71 | 0.69 |
| (g/ml) | | | | | | | | | | | | | |
| Hygroscopicity | 1.2 | 1.5 | 1.61 | 0.11 | 0.14 | 0.13 | 1.4 | 4.0 | 2.0 | 0.37 | 0.09 | 0.12 | 0.10 |

Samples A, J, O and Q (tables 6 and 7) exhibit a high content of particles of less than 75 μm, respectively of 65.9%, 84.4%, 78.2% and 71.1%. Furthermore, they exhibit poor flow, reflected by a low flow grade of respectively 41.5, 47, 49 and 47. Other samples, although comprising a lower amount of particles having a particle size of less than 75 μm, exhibit a low flow grade; such is the case with samples B, M and S, which respectively exhibit a percentage of particles of less than 75 μm of 33.5%, 30.3% and 58.7% for a flow grade of 51.5, 41 and 34.

On the other hand, it must be noted that samples C to I, K, L, N, P, R, T to X and Z comprise both good flow, namely greater than 55, and a good particle size profile with a percentage of powder having a particle size of less than 75 μm of less than 60%. Thus, powders formed of mannitol, maltitol, xylitol or isomalt or of xylitol/BMD or mannitol/starch mixture having a very good flow grade and a low amount of particles having a fine particle size could be obtained.

In order to achieve a flow grade of greater than 60, it is preferable to use a powder for which the content of particles of less than 75 μm is less than 50%.

The addition of talc does not make it possible to improve the flow grade of the pulverulent composition. Thus, in the case of sample F, which exhibits, of all the agglomerated products, the lowest flow grade (54) and also the highest content of particles of less than 75 μm (56.2%), the addition of 10% of talc (sample Y) results in an increase in the content of particles of less than 75 μm and in a slight improvement in the flow grade.

### EXAMPLE 2

Chewing gum is produced industrially on a Togum (Bosch-Togum) brand production line.

This operation is carried out with a standard “sugar-free” chewing gum formulation:

Base gum: 32%

Sorbitol powder (Neosorb® P60W): 49%

Mannitol 60: 7%

Maltitol syrup (Lycasin® 80/55HDS): 9%

Glycerol: 0.2%

Aspartame: 0.2%

Mint flavoring, liquid: 2.1%

Mint flavoring, powder: 0.5%

The mixing step is carried out in a Togum GT120 Z-arm kneading machine with a capacity of approximately 60 kg. Mixing is carried out continuously.

At t=0, the base gum, preheated overnight at 50° C., and half the sorbitol powder are introduced into the kneading machine. At t=3 min, the mannitol is introduced, at t=5 min, the maltitol syrup is introduced, at t=7 min, half of the sorbitol and the aspartame are introduced, at t=11 min, the glycerol is introduced and, at t=12 min, the flavorings are introduced. At t=16 min, mixing is halted and the paste is discharged. The temperature of the paste is then approximately 55° C. The latter is divided into bars of approximately 2 kg which are stored at 20° C., 50% relative humidity, for 1 hour, which will bring the temperature of the paste to 47° C. before extrusion.

The extrusion step is carried out on a Togum TO-E82 device, with the body of the extruder heated to 40° C. and the head heated to 45° C.

The dusting step and the rolling step are carried out on a Togum TO-W191 rolling mill. It is equipped firstly with two dusting stations, one situated over the top of the extruded strip of chewing gum and one above a conveyor belt situated below the strip of chewing gum, the role of which is to contribute the dusting powder over the lower face of the chewing gum. Thus, the strip of chewing gum is dusted over both faces before the first rolling station. It is subsequently equipped with 4 pairs of rolling rollers with, situated between the second and the third pairs, a dust-removing system composed of a pair of brushes, one situated over the bottom and the other over the top of the strip of chewing gum. This system serves to remove the excess powder on both faces of the strip of chewing gum. Finally, it is equipped with two pairs of rollers for the forming and the cutting, in order to confer the desired final form on the chewing gum, in the present case cushions.

The reference powders A to Z of example 1 were tested in dusting. The dusting powder was composed solely of these samples: no talc was added, except for sample Y, which is a mixture of agglomerated mannitol and talc.

The observations made (table 8) were: the ease in obtaining flow of the powder from the dusting equipment, the control of the amount of powder deposited with respect to the desired amount, the amount of powder lost, the formation of dust in suspension in the air, and the appearance of the chewing gum after the removal of dust.

The “flow of the powder from the dusting equipment” characteristic is observed with respect to the homogeneity in deposition of powder over the width of the strip of chewing gum and also with regard to variations in the flow rate for deposition of dusting powder during the process for the manufacture of chewing gums.

The “control of the amount of powder deposited with respect to the desired amount” characteristic corresponds to the possibility of regulating the amount of deposited material.

The “amount of powder lost” corresponds to the ratio of the amount of powder deposited on the strip of chewing gum with regard to that recovered after the removal of dust from the strip of chewing gum.

The “formation of dust in suspension in the air” corresponds to a visual comparison of the density of powder which has passed into the air during the implementation of the process.

The “appearance of the chewing gum after the removal of dust” corresponds to visual observation of nonuniformity in the layer of powder after dusting and removal of dust.

All these characteristics were graded on a scale of intensity.

Furthermore, the chewing gums were tested by a panel of 15 people in order to determine if the increase in the size of the particles of the dusting powder confers a gritty texture on the chewing gum. The tests are carried out according to standard AFNOR V 09-014 (April 1982) on samples A to Z per group of 5 or 6 samples per test. The 5 or 6 samples were presented simultaneously, a different order of tasting being stipulated for each member of the panel. The descriptor stipulated, namely the gritty nature in the mouth, is evaluated on a 9-point scale graded in the following way: absence, very slight, slight, marked, pronounced or very pronounced. The analysis of variance (Friedman's ANOVA) distinguishes the samples with regard to their gritty natures (p<<0.05). The values obtained are shown in table 8.

In table 8, the symbols correspond to the following meanings.

For the flow of the powder and the control of the amount of powder dusted: “++”=very good, “+”=good, “+/−”=fair, “−”=poor and “−−”=very poor.

For the amount of powder lost and the amount of particles in suspension: “−−”=very high, “−”=high, “+/−”=slight and “+”=very slight.

TABLE 8

| | Flow of the | Control of | Amount | | Appearance of | Gritty |
|---|---|---|---|---|---|---|
| | powder from | the amount | of | Particles in | the chewing | sensation on |
| | the dusting | of powder | powder | suspension | gum after the | tasting in |
| Sample | equipment | dusted | lost | in the air | removal of dust | the mouth |
| A | −− | −− | −− | −− | C | ++ |
| B | − | − | −− | − | C | ++ |
| C | ++ | ++ | ++ | ++ | C | + |
| D | ++ | ++ | ++ | ++ | C | + |
| E | ++ | + | ++ | ++ | C | + |
| F | + | ++ | ++ | − | C | +/− |
| G | ++ | + | ++ | ++ | C | +/− |
| H | ++ | ++ | ++ | ++ | C | +/− |
| I | ++ | ++ | ++ | ++ | +/− | +/− |
| J | −− | −− | −− | −− | C | ++ |
| K | ++ | ++ | ++ | +/− | C | +/− |
| L | ++ | ++ | ++ | ++ | C | +/− |
| M | −− | −− | −− | ++ | C | + |
| N | ++ | ++ | ++ | ++ | +/− | + |
| O | +/− | −− | −− | −− | C | +/− |
| P | ++ | ++ | ++ | ++ | C | + |
| Q | −− | −− | −− | −− | C | ++ |
| R | ++ | ++ | ++ | ++ | C | ++ |
| S | −− | −− | −− | −− | C | ++ |
| T | ++ | ++ | ++ | ++ | C | + |
| U | ++ | ++ | ++ | ++ | +/− | +/− |
| V | ++ | ++ | ++ | ++ | C | ++ |
| W | ++ | ++ | ++ | ++ | +/− | +/− |
| X | + | ++ | + | ++ | C | +/− |
| Y | ++ | ++ | ++ | − | C | + |
| Z | ++ | ++ | ++ | ++ | C | +/− |

For the characteristic of gritty sensation during tasting in the mouth: “++”=absence, very slight, “+/−”=slight.

For the appearance of the chewing gum after the removal of dust, “C”=appearance conforms (upper and lower surfaces uniformly dusted), “+/−”=the amount remaining after removal of dust forms a nonuniform layer; regions which have been dusted to an excessively slight extent remain, forming sticking regions along the strip of chewing gum.

Samples I, N, U and W, which exhibit a very high mean diameter of 343, 341, 290 and 265 μm respectively and a very low content of particles of less than 75 μm of 3.8, 2.4, 2.2 and 4.5% respectively, give the strip of chewing gum, after removal of dust, a nonuniform layer of powder insufficient to provide effective dusting.

Sample K, which exhibits a mean diameter of 89 μm, generated slightly more particles in suspension in the air than the other granulated products.

Samples A, B, J, M, O, Q and S (table 8), which exhibit a high content of particles of less than 75 μm, exhibit poor flow, which makes it difficult to regulate the dusting equipment and thus to control the amount deposited. Consequently, the level of loss is high. Furthermore, because of the presence of fines, the content of particles in suspension in the air is high.

Sample F exhibits an improved but improvable flow and its high content of particles of less than 75 μm (56.2%) is the cause of dust. It is noticed that the addition of talc to sample F (sample Y) improves the homogeneity of deposition, the consistency of the latter during the process and the organoleptic qualities (gritty sensation in the mouth) but does not reduce the particles present in the air.

Samples C, D, E, G, H, I, K, L, N, P, R and T to Z, exhibiting less than 50% of particles of less than 75 μm and a flow grade of greater than 60, have a flow which makes it possible to control the amount of powder deposited and to limit the losses. Furthermore, the low amount of particles in suspension is an advantage for the cleanliness of the sites and the health of the operators. Furthermore, the increase in the mean diameter of the powders does not have negative consequences with regard to the organoleptic qualities of the chewing gum obtained: the tasting in the mouth did not reveal any gritty sensation in the mouth, the particle size being compensated for by the high solubility of the agglomerates of polyols.

### EXAMPLE 3

A caking test is carried out in a laboratory. This test makes it possible to simulate the caking which appears in big bags (bags containing from 500 to 1500 kg of powder) of the powders or along the storage regions of the line for the production of chewing gums.

An amount of 1300 grams of product is placed in a polyethylene sachet, the polyethylene having a thickness of 100 μm (flat size of 32.4 cm by 20.9 cm). This sachet is subsequently hermetically closed after having driven off as much occluded air as possible. It is subsequently placed in a perforated cylinder, with a height of 22 cm and a diameter of 13 cm, pierced with holes with a diameter of 8 mm which are arranged in staggered rolls with a distance of 12 mm between the centers of the neighboring holes. A metal disk with a diameter just less than that of the cylinder is placed on the sachet. A weight of 6.6 kg is placed on this disk, i.e. the equivalent of a pressure of 580 kg/m², a pressure identical to that which the powder situated at the bottom of a big bag is subjected to.

The setup is subsequently placed in a climate-controlled chamber regulated so as to subject it to 15 cycles of 6 hours (3 hours at a temperature of 15° C. and a relative humidity of 85%, followed by 3 hours at a temperature of 30° C. and a relative humidity of 85%).

At the end of these cycles, the sachet is carefully removed from the cylinder and cut open. A first observation of the powder is carried out. All of the powder is subsequently introduced into a can with a working volume of 5 liters (total volume of 6 liters with a diameter for the opening greater than the diameter of the perforated cylinder), which is rotated for one minute in a Mixomat A14 (Fuchs/Switzerland) tumbler mixer. All the powder is subsequently poured onto a sieve, the meshes of which have square openings of approximately 8 mm by 8 mm. Thus, only the cakes of product with a diameter of more than approximately 8 mm are recovered, the total weight of which is measured. The level of caked product is calculated by dividing the weight of these cakes by the starting weight of sample employed (1300 grams).

TABLE 9

| Sample | A | B | C | D | E | F | G | H | I | J |
|---|---|---|---|---|---|---|---|---|---|---|
| Appearance of | −− | − | + | + | + | +/− | +/− | +/− | + | −− |
| the powder | | | | | | | | | | |
| Level of caked product | 29% | 20% | 3% | 5% | 3% | 16% | 11% | 12% | 0% | 47 |

TABLE 10

| Sample | K | L | M | N | Q | R | S | T | U | V |
|---|---|---|---|---|---|---|---|---|---|---|
| Appearance of | − | +/− | −− | + | −− | + | −− | +/− | + | + |
| the powder | | | | | | | | | | |
| Level of caked product | 29% | 22% | 75% | 0% | 38% | 0% | 85% | 17% | 0% | 0% |

As regards the characteristic of the appearance of the powder (tables 9 and 10): “+”=fluid powder, “+/−”=presence of crumbly blocks, “−”=presence of hard blocks, “−−” presence of very hard blocks.

Samples A, J, M, Q and S (see tables 9 and 10) exhibit a very high level of caked product (from 29 to 85%) and very hard blocks. They are unsuitable for delivery in big bags since it is very difficult, indeed even impossible, to remove such hard blocks from big bags.

Furthermore, the equipment used to convey and sprinkle the powder during the production of the chewing gum is designed for a powder devoid of very hard agglomerates which present the risk at any moment of blocking and stopping the dusting, the consequence of which is the virtually immediate shutdown of the line, the strip of chewing gum sticking over the whole of the plant.

In order to use these samples, a grinding and a sieving will be essential.

Sample B (see table 9) has a high level of caked product (20%), which indicates that the powder situated at the bottom of the big bags will acquire cohesion very rapidly after filling and that these big bags will become very difficult to empty. This packaging is thus inadvisable for this sample. At the very least, this storage will have to be very limited in time. For samples F, G, H and T, which exhibit a level of caking from 11% to 17%, this packaging can be envisaged as the blocks observed are crumbly and can be destroyed by simple sieving. For samples C, D, E, I, N, R, U and V, which exhibit very low levels of caked product (<5%) and often zero levels, the filling, storing and emptying of big bags will not present any difficulty: they can be sold without concern in this type of device and can be used subsequently in the dusting of the strip of chewing gum without any reprocessing.

1. A method for producing chewing gums comprising a step of mixing the ingredients, a step of extruding the mixture, a step of dusting with a dusting powder, a step of rolling and a step of forming/cutting, wherein said dusting powder comprises a pulverulent composition formed of agglomerates of crystals, said pulverulent composition comprising at least one polyol.

2. The method as claimed in claim 1, wherein said composition formed of agglomerates of crystals exhibits a flow grade of between 55 and 90.

3. The method as claimed in claim 1, wherein said polyol exhibits a hygroscopicity of between 0.01 and 5%.

4. The method as claimed in claim 1, wherein said composition formed of agglomerates of crystals comprises less than 60% of particles with a diameter of less than 75 μm.

5. The method as claimed in claim 1, wherein said composition formed of agglomerates of crystals comprises from 50% to 0.1% of particles with a diameter of less than 75 μm.

6. The method as claimed in claim 1, wherein said composition formed of agglomerates of crystals comprises more than 50% of polyol.

7. The method as claimed in claim 1, wherein said polyol is a hydrogenated monosaccharide, hydrogenated disaccharide or their mixture.

8. The method as claimed in claim 7, wherein said polyol is chosen from mannitol, isomalt, xylitol, maltitol, erythritol, lactitol, sorbitol and their mixtures.

9. The method as claimed in claim 1, wherein said pulverulent composition exhibits a mean diameter D4,3 of between 75 μm and 400 μm.

10. The method as claimed in claim 1, wherein the agglomerates of crystals are obtained by granulation of crystals, said crystals being obtained by single or fractional crystallization.

11. The method as claimed in claim 10, wherein the agglomerates of crystals are obtained by granulation of crystals, said crystals being obtained by crystallization by cooling a melt, by evaporation or evaporative crystallization of a polyol solution or by addition of a diluent.

12. The method as claimed in claim 1, wherein the dusting powder comprises less than 50% of a silicate or carbonate.

13. The method as claimed in claim 1, wherein the pulverulent composition comprises a protein or a polysaccharide preferably chosen from starches, maltodextrins, dextrins, gums, pectin and cellulose derivatives or their mixture.

14. A chewing gum obtained by the implementation of the method as claimed in claim 1, wherein it comprises, at the surface of the chewing gum, a dusting powder comprising a pulverulent composition formed of agglomerates of crystals, said pulverulent composition comprising at least one polyol.

15. The method as claimed in claim 2, wherein said polyol exhibits a hygroscopicity of between 0.01 and 5%.
